(19) United States
(12) Patent Application Publication
(10) Pub. No.: US 2009/0174565 A1
(43) Pub. Date: Jul. 9, 2009

(54) FALL DETECTION SYSTEM

(75) Inventors: Chung Man Chan, Hong Kong (HK); Ching Ching Cheung, Hong Kong (HK); Ka Lun Fan, Hong Kong (HK); Hung Keung Tse, Hong Kong (HK)

Correspondence Address: GRAY, PLANT, MOOTY, MOOTY & BENNETT, P.A., P.O. BOX 2906, MINNEAPOLIS, MN, 55402-0906, US

(73) Assignee: AVITON CARE LIMITED, Kwun Tong (HK)

(21) Appl. No.: 11/969,238

(22) Filed: Jan. 4, 2008

(51) Int. Cl. G08B 21/00

(52) U.S. Cl. 340/669

(57) ABSTRACT

A fall detection system a first fall sensing module and a notifying module. The first fall sensing module has a rotational portion and a sensing portion. The sensing portion monitors movement of the rotational portion. The notifying module is capable of emitting a sound, emitting a light, transmitting a message, initial a call or combination thereof to indicate that the first fall sensing module has been activated.

### FIELD OF THE INVENTION

The invention relates generally to a personal safety product. More particularly, the invention relates to a fall detection system.

### BACKGROUND OF THE INVENTION

As society evolves and persons live longer, there is a greater likelihood that persons will live to an age where at least a portion of the person's ability to control bodily activities is reduced. For example, the person may have a decreased balance. Especially when an older person falls, there is a greater likelihood that the person will break bones from such a fall. It is not always possible for another person to watch the older person such that it can be immediately determined when a fall has occurred.

Several U.S. patents and patent publications disclose systems for detecting when a person has fallen. Examples of these references include Lehrman et al., U.S. Pat. Nos. 6,661,347 and 6,703,939; Clifford et al., U.S. Patent Publication No. 2006/0214806; and Petelenz et al., U.S. Patent Publication No. 2001/0004234.

Each of these fall detection system evaluates accelerative movement of a person that is indicative of a person falling. The fall detection systems also generally include a system for notifying others that the person has fallen along with the location of the fall.

### SUMMARY OF THE INVENTION

The fall detection system is carried by a user to monitor his/her body orientation. When it detects the user lying down for a period longer than a preset value, a sound, a call, a message and/or light alarm will be generated for alerting other people.

### BRIEF DESCRIPTION OF THE DRAWINGS

FIG. 1 is a front view of a fall detection system according to an embodiment of the invention.

FIG. 2 is a back view of the fall detection system of FIG. 1.

FIG. 3 is a side view of the fall detection system of FIG. 1.

FIG. 4 is a back perspective view of the fall detection system of FIG. 1.

FIG. 5 is top view of the fall detection system of FIG. 1.

FIG. 6 is a bottom view of the fall detection system of FIG. 1.

FIG. 7 is a back perspective view of the fall detection system with a mounting clip attached thereto.

FIG. 8 is a back view of the fall detection system of FIG. 7.

FIG. 9 is a side view of the fall detection system of FIG. 7.

FIG. 10 is a top view of the fall detection system of FIG. 7.

FIG. 11 is a bottom view of the fall detection system of FIG. 7.

FIG. 12 is a back perspective view of the fall detection system with a strap assembly attached thereto.

FIG. 13 is a front view of the fall detection system of FIG. 12.

FIG. 14 is a back view of the fall detection system of FIG. 12.

FIG. 15 is a side view of the fall detection system of FIG. 12.

FIG. 16 is a top view of the fall detection system of FIG. 12.

FIG. 17 is a bottom view of the fall detection system of FIG. 12.

FIG. 18 is a block diagram of aspects of the fall detection system.

FIG. 19 is a flow diagram illustrating operation of the fall detection system.

FIG. 20 is a top view of a sensor plate for the fall sensor.

FIG. 21 is a graph of readings from a fall sensor for a person who has experienced a fall.

FIG. 22 is a graph of readings from the fall sensor for a person who is walking.

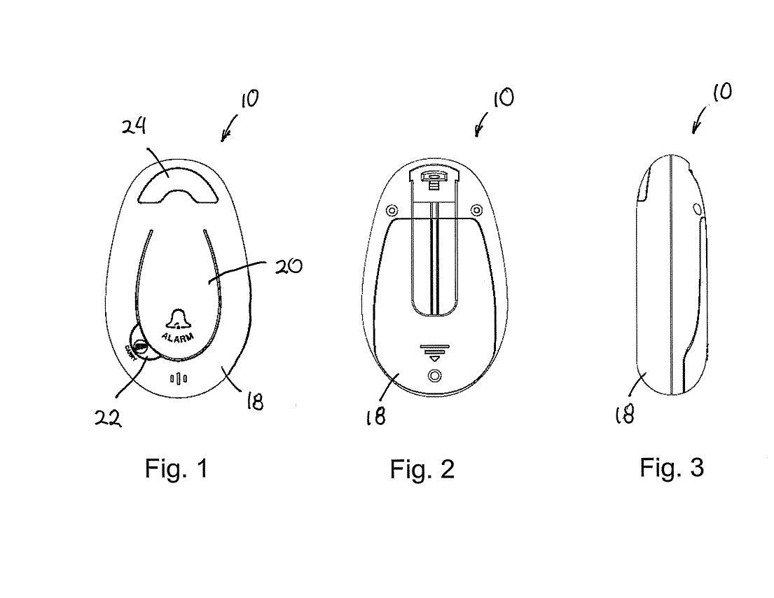

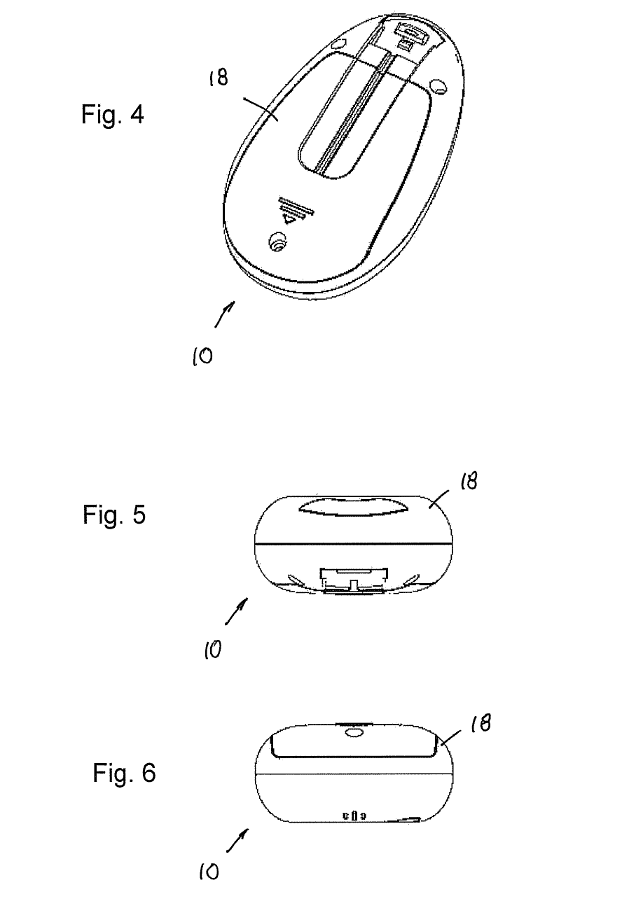

### DETAILED DESCRIPTION OF THE PREFERRED EMBODIMENTS

The invention is fall detection system, as illustrated at 10 in the Figures. The fall detection system 10 thereby facilitates providing prompt assistance to persons who have fallen and decreases the time for the person to receive medical attention, which decreases the potential of further complications resulting from the fall.

The fall detection system 10 generally includes an outer enclosure 18 in which the components of the fall detection system 10 are contained. The outer enclosure 18 may be fabricated from a variety of materials depending on the desired appearance of the fall detection system 10 and the conditions under which the fall detection system 10 is to be used. In one configuration, the outer enclosure 18 is fabricated from injection molded plastic.

To enhance the simplicity of using the fall detection system 10, the outer enclosure 18 has a minimal amount of controls. An alarm button 20 may occupy a relatively large portion of at least one surface of the outer enclosure 18 to enhance the ability to depress the alarm button 20 in case of an emergency.

A stop button 22 may also be provided on the outer enclosure 18. The stop button 22 may have a size that is considerably smaller than the size of the alarm button 20. Forming the stop button 22 in this manner reduces the potential that the fall detection system 10 may be inadvertently deactivated when in the alarm mode.

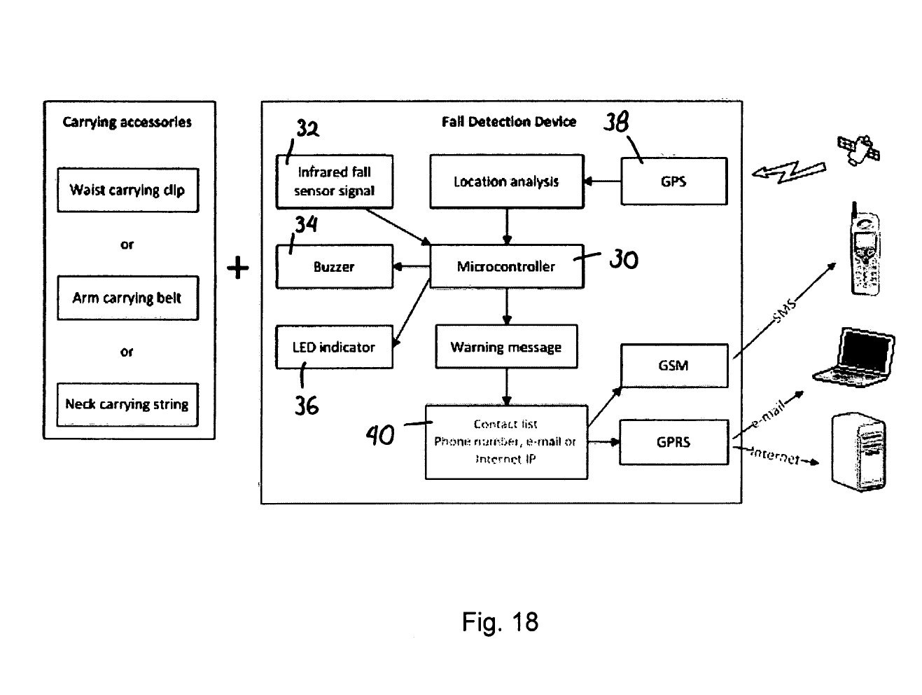

Inside of the outer enclosure 18 components necessary for the operation of the fall detection system 10 are located. The components may include a microprocessor module 30, a fall sensing module 32, a sound generation module 34, a light emitting module 36, a location determining module 38, and a message transmission module 40, as illustrated in FIG. 18.

The fall sensing module 32 may include at least one fall sensor. In one embodiment, the fall sensor is an infrared fall sensor. In one configuration, the fall sensing module 32 includes two fall sensors that each detect motion along an axis. Wherein the axes are approximately perpendicular to each other and each approximately normal to a vertical axis when the fall detection system 10 is worn by a person.

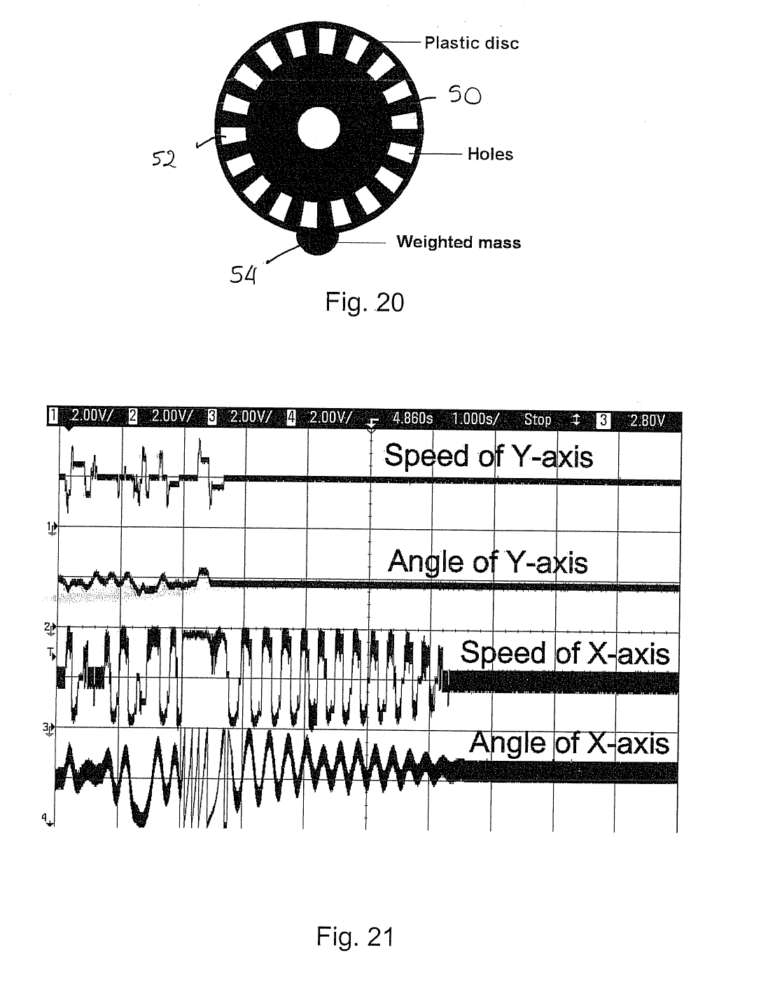

Each of the fall sensors may include a sensor plate 50 movably mounted therein that includes a plurality of apertures 52 formed therein, as illustrated FIG. 20. The sensor plate 50 may have a generally round shape and the apertures 52 may each be mounted at an approximately equal distance from an edge of the sensor plate 50. The apertures 52 may each have an approximately equal size and be spaced-apart an approximately equal distance.

At least one weighted mass 54 may be attached to the sensor plate 50. In one configuration, the weighted mass 54 may be located adjacent to or beyond an edge of the sensor plate 50. The weighted mass 54 may have a weight that is greater than a weight of the sensor plate 50 such that intertial force of the weighted mass 54 causes the sensor plate to rotate. The sensor plate 50 is mounted with a mechanism that permits the sensor plate 50 to rotate with relatively low frictional resistance.

The fall sensors each also include a sensing system for evaluating the rotation of the sensor plate. In one configuration, the sensing system includes an emitter that is capable of emitting a light. One suitable emitter emits light in the infrared spectrum. Using light with a wavelength in this range minimizes interference with the operation of the fall sensors is visible light enters the fall sensors.

The sensing system also includes a receiver that is capable of receiving light from the emitter. A person of ordinary skill in the art will appreciate that the type of receiver is selected based upon the type of emitter used in the fall sensor. In one configuration, the receiver is a 2-phase infrared receiver.

Each of the fall sensors thereby monitors the rotational speed and position of the sensor plate mounted therein. The information from the fall sensors is combined to analyze the body movement and thereby detect when a fall has occurred.

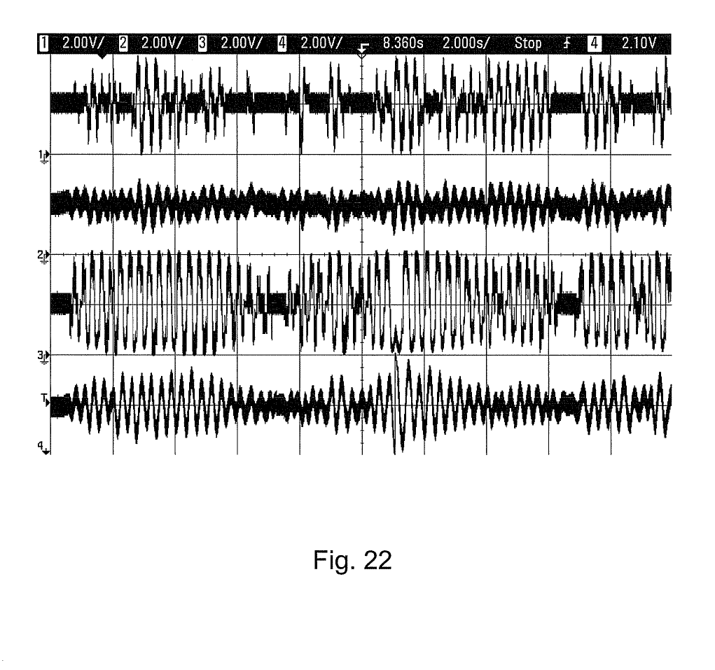

FIGS. 21 and 22 include data from the fall sensors. The first line in each figure is the speed of the Y-axis. The second line in each figure is the angle of Y-axis. The third line in each figure is the speed of the X-axis. The fourth line in each figure is the angle of the X-axis. FIG. 21 illustrates when a fall has occurred while FIG. 22 illustrates when a person is walking.

It is also possible for the sensor module 32 to include a tilt sensor that monitors the orientation of the person's body. The tilt sensor is particularly useful for determining when a person has not moved for more than a specified period of time. One suitable tilt sensor is available as model TS-0002 from Solteam Opto, Inc.

In one embodiment, the sound generation module 34 is a speaker. In one embodiment, the location determining module 38 is a GPS module. In one embodiment, the message transmission module 40 is capable of emitting a wireless signal, which is described in more detail below. To enhance the mobility of the fall detection system 10, the components of the fall detection system 10 may be powered by a battery (not shown). The fall detection system 10 may include the ability to recharge the battery.

The fall detection system 10 is adaptable to attachment to the person using a variety of configurations. An important criteria would be that the method of attaching the fall detection system 10 to the person's body is that the attachment mechanism resists inadvertent detaching from the person, as inadvertent detaching could lead to false alarms and/or damage to the fall detection system 10.

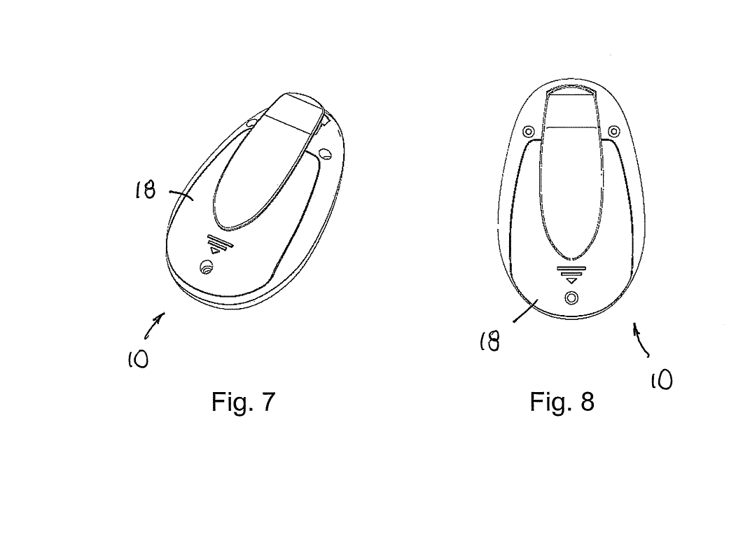

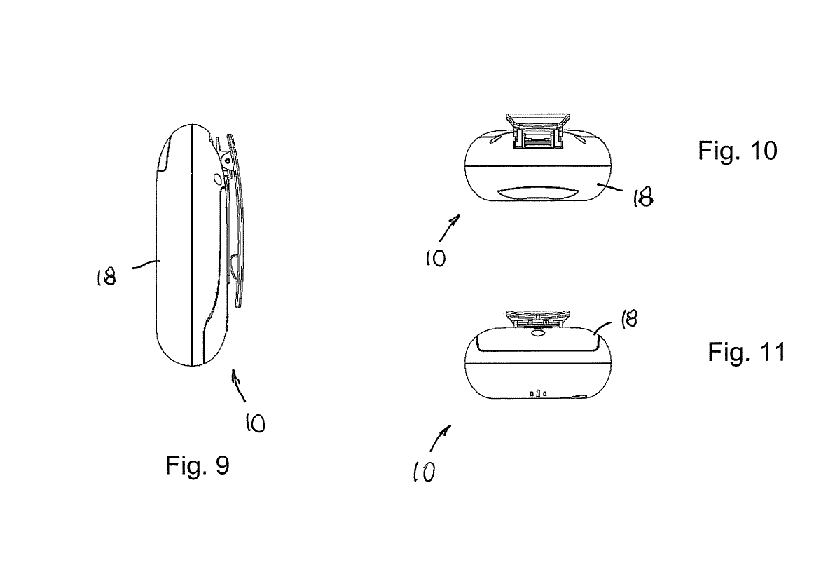

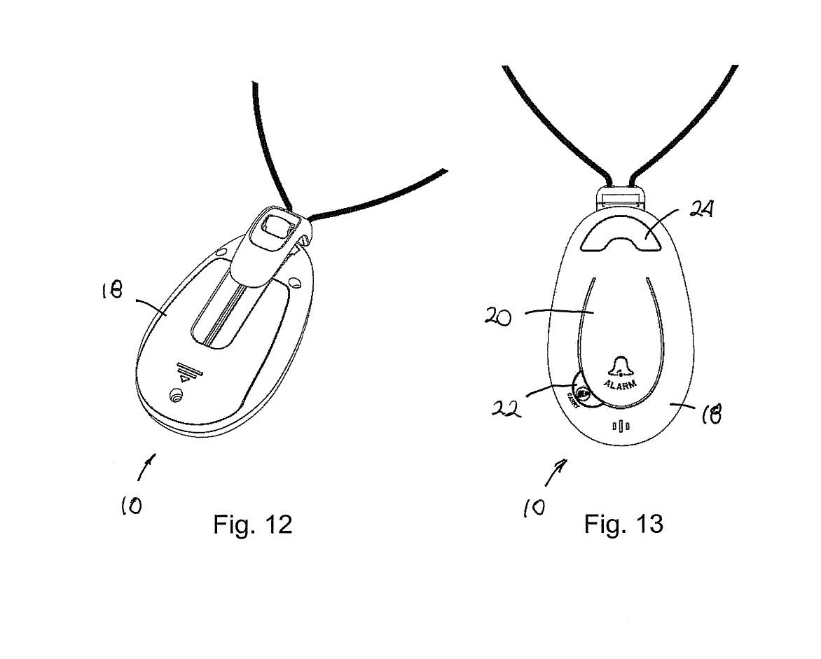

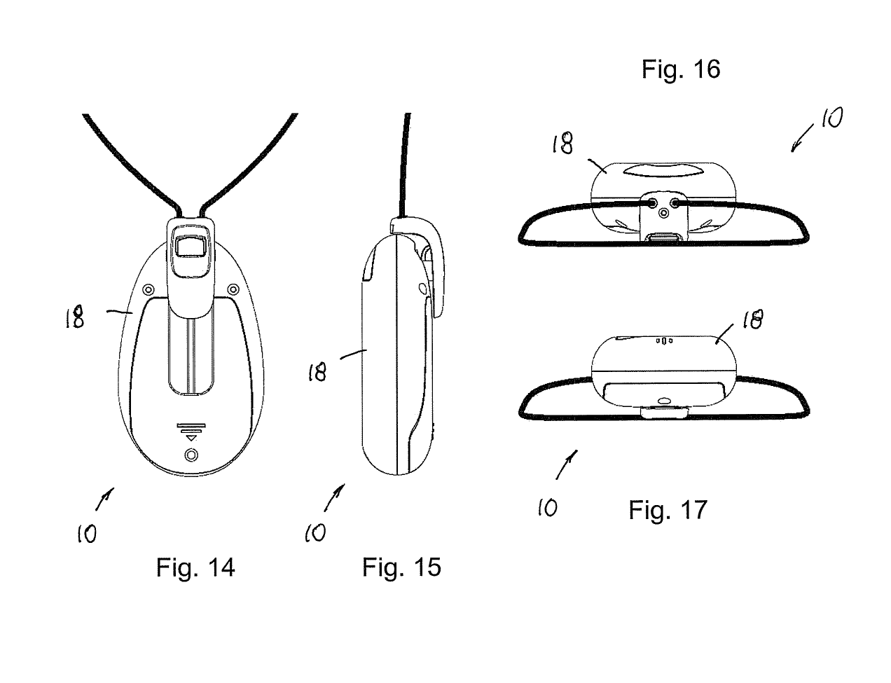

Two particular configurations include clipping on a person's clothing (as illustrated in FIGS. 7-11) and hanging around a person's neck (as illustrated in FIGS. 12-17). The fall detection system 10 may also be attached to other portions of the person's body such as the arm with a strap. The fall detection system 10 may facilitate readily changing between attachment mechanisms such as when the activity being performed by the person is changed.

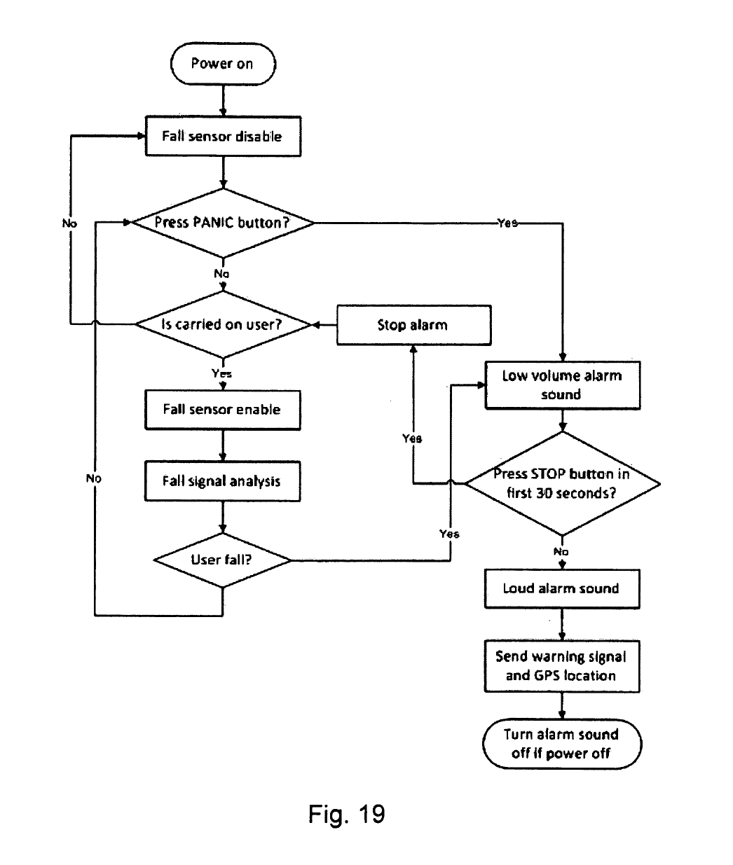

A logic flow diagram for the fall detection system is illustrated in FIG. 19. The fall detection system 10 may monitor movement and/or orientation of the person using the fall detection system 10. For example, the fall detection system 10 may be activated if the person lays down for more than a specified period of time. This inactivity could be indicative that the person has lost consciousness.

Alternatively or additionally, the fall detection system 10 may also detect when the person's body moves in a manner that is indicative of the person falling. If the fall detection system 10 is not carried by the person, the fall sensor may be disabled to avoid a false alarm.

In operation, the fall detection system 10 is enabled by attaching the fall detection system 10 to a person using one of the mechanisms set forth above. When a period of inactivity or a fall is detected, the fall detection system 10 emits a low volume sound alarm for a first selected period of time. In one configuration the first selected period of time is less than 60 seconds and preferably is about 30 seconds. The fall detection system 10 thereby provides a relatively short period of time for the person to press the stop button 22 such as if the fall detection system 10 was inadvertently activated.

The low volume sounds alarm may be accompanied by a light displayed on the fall detection system 10. The light can be generated from a variety of sources, utilizes a variety of colors and be displayed in a variety of patterns. One suitable light source is a red LED. One suitable display pattern is flashing to attract more attention to the light.

If the stop button 22 is not pressed in the first selected period of time, a high volume sound alarm is initiated. The fall detection system 10 may be configured such that the high volume sound alarm cannot be stopped by pressing the stop button 22. In one configuration, the fall detection system 10 must be detached from the person and then the stop button pressed 22 to discontinue the high volume alarm discussed above and message transmission discussed below.

A light 24 may also accompany the high volume sound alarm. Such light may be a different color, intensity and be displayed in a different pattern than the light that accompanies the low volume sound alarm.

If the high volume sound alarm remains on for more than a second selected period of time, the fall detection system 10 may transmit a message such as using SMS or email that contains information about the person such as the person's name and location as determined by the GPS module. In one configuration, the second selected period of time is less than about 60 seconds and preferably is about 30 seconds.

The message may be transmitted using a variety of communication protocols such as GSM and GPRS. The message may be transmitted over a public communication network, a private communication network, or combination thereof.

Alternatively or additionally, the message may be transmitted via a computer network such as the internet such that the message may be viewed on a remote computer system.

The fall detection system 10 may continue to transmit messages regarding the fall at selected intervals. In one configuration, the selected intervals are less than 5 minutes and preferably are about 2 minutes.

Another technique to activate the fall detection system 10 is for the person to press the alarm button 20. Similar to activation after a fall, the fall detection system 10 may utilize one or more of the following low volume sound alarm, high volume sound alarm and message transmission.

It is contemplated that features disclosed in this application, as well as those described in the above applications incorporated by reference, can be mixed and matched to suit particular circumstances. Various other modifications and changes will be apparent to those of ordinary skill.

1. A fall detection system comprising:
a first fall sensing module having a rotational portion and a sensing portion, wherein the sensing portion monitors movement of the rotational portion; and
a notifying module that is capable of emitting a sound, emitting a light, transmitting a message, initial a call or combination thereof to indicate that the first fall sensing module has been activated.

2. The fall detection system of claim 1, and further a second fall sensing module, wherein the first fall sensing module and the second fall sensing modules are oriented to sense motion along different axes.

3. The fall detection system of claim 1, wherein the rotational portion comprises a disk having a plurality of apertures formed therein.

4. The fall detection system of claim 3, wherein the plurality of apertures have an approximately equal size, are spaced at an approximately equal distance, or combination thereof.

5. The fall detection system of claim 3, wherein the rotational portion further comprises a weighted mass having a weight that is greater than the weight of the rotational portion.

6. The fall detection system of claim 1, wherein the sensing portion comprises an infrared sensor, a tilt sensor or combination thereof

7. The fall detection system of claim 1, and further comprising:
an alarm button for activating the notifying module; and
a stop button for deactivating the notifying module.

8. The fall detection system of claim 1, and further comprising a location determining module having GPS capabilities.

9. The fall detection system of claim 1, and further comprising a communication module that is capable of transmitting a signal over at least one communication protocol, wherein the signal contains details regarding activation of the fall detection system, a location of the fall detection system when activated, a time at which the fall detection system was activated, a date on which the fall detection system was activated or combination thereof.

10. The fall detection system of claim 1, and further comprising a clip, a belt or a string attached thereto.

11. A method of detecting when a person has fallen, wherein the method comprises:
monitoring movement of a person using a first fall sensing module having a rotational portion and a sensing portion, wherein the sensing portion monitors movement of the rotational portion and activates the first fall sensing module when selected parameters exist; and
emitting a sound, emitting a light, transmitting a message, initial a call or combination thereof from a notifying module to indicate that the first fall sensing module has been activated.

12. The method of claim 11, wherein the fall detection system is activatable in a fall mode or a panic mode, wherein the fall mode is activated with the first fall sensing module, and wherein the panic mode is activated by pressing an alarm button.

13. The method of claim 11, wherein the fall detection system is activatable in a first activation mode and a second activation mode, wherein the fall detection system is initially activated in the first activation mode, and wherein the second activation mode is activated if the first activation mode is not canceled within a first time period.

14. The method of claim 11, wherein the first fall sensing module monitors movement of the person along a first axis, wherein the method further comprises monitoring movement of the person along a second axis using a second fall sensing module, and wherein the first axis is oriented differently than the second axis.

15. The method of claim 11, wherein the rotational portion comprises a disk having a plurality of apertures formed therein, and wherein the plurality of apertures have an approximately equal size, are spaced at an approximately equal distance, or combination thereof.

16. The method of claim 15, and further comprising attaching a weighted mass to the rotational portion, wherein the weighted mass has a weight that is greater than the weight of the rotational portion.

17. The method of claim 11, wherein monitoring the movement of the rotational portion utilizes an infrared sensor.

18. The method of claim 11, and further comprising:
activating the notifying module with an alarm button; and
deactivating the notifying module with a stop button.

19. The method of claim 11, and further comprising determining a location of the fall detection system when activated with a location determining module having GPS capabilities.

20. The method of claim 11, and further comprising transmitting a signal over at least one communication protocol from a communication module, wherein the signal contains details regarding activation of the fall detection system, a location of the fall detection system when activated, a time at which the fall detection system was activated, a date on which the fall detection system was activated or combination thereof.

21. The method of claim 11, and further comprising attaching a clip, a belt or a string to the fall detection system.
